(19) United States
(12) Patent Application Publication
(10) Pub. No.: US 2019/0046920 A1
(43) Pub. Date: Feb. 14, 2019

(54) CARBON DIOXIDE RECOVERY SYSTEM AND CARBON DIOXIDE SEPARATION AND RECOVERY SYSTEM

(71) Applicant: KAWASAKI JUKOGYO KABUSHIKI KAISHA, Kobe-shi, Hyogo (JP)

(72) Inventors: Shohei NISHIBE, Kobe-shi (JP); Hidekazu IWASAKI, Kobe-shi (JP); Katsuhiro YOSHIZAWA, Akashi-shi (JP); Takeshi OKUMURA, Kobe-shi (JP)

(73) Assignee: KAWASAKI JUKOGYO KABUSHIKI KAISHA, Kobe-shi, Hyogo (JP)

(21) Appl. No.: 16/075,928

(22) PCT Filed: Feb. 6, 2017
(86) PCT No.: PCT/JP2017/004209

§ 371 Date: Aug. 6, 2018

(30) Foreign Application Priority Data
Feb. 4, 2016 (JP) 2016-019743

(51) Int. Cl. B01D 53/08; B01D 53/14; B01D 53/62; B01D 53/83; B01D 53/96

(52) U.S. Cl. CPC B01D 53/08; B01D 53/14; B01D 53/62; B01D 53/83; B01D 2253/25; B01D 2257/504; B01D 2257/80; B01D 2259/4009; B01D 2252/204; B01D 53/96

(57) ABSTRACT

A carbon dioxide recovery system includes: a desorption vessel configured to cause carbon dioxide to be desorbed from an absorbent; a carbon dioxide holder connected to desorption vessel via the desorption vessel and carbon dioxide recovery pipe; a pump configured to feed gas in the desorption vessel to the carbon dioxide holder via carbon dioxide recovery pipe; and at least one pressure switching device including at least one stage of hopper, an inlet valve configured to open and close the hopper's inlet port, an outlet valve configured to open and close the hopper's outlet port, an exhaust pipe connected to the hopper and configured to exhaust the hopper, an exhaust valve configured to open and close the exhaust pipe, an air supply pipe connected to the hopper and configured to supply carbon dioxide to the hopper, and an air supply valve configured to open and close the air supply pipe.

### TECHNICAL FIELD

The present invention relates to a carbon dioxide recovery system configured to recover carbon dioxide desorbed from a carbon dioxide absorbent, and a carbon dioxide separation and recovery system including the carbon dioxide recovery system.

### BACKGROUND ART

Separation of carbon dioxide from gas containing carbon dioxide, that is, gas to be processed, by using a carbon dioxide absorbent has been conventionally performed. The absorbent that has absorbed carbon dioxide is recovered by desorbing the carbon dioxide and is used for absorbing carbon dioxide again. A system for performing absorption and desorption of carbon dioxide with respect to the carbon dioxide absorbent is disclosed in PTL 1.

The carbon dioxide separation and recovery system of the related art disclosed in PTL 1 includes a hopper, an adsorption tower, a recovery tower, a dryer tower, a cooling tower, and a conveyer configured to transfer the absorbent from the cooling tower to the hopper, which are arranged downward in sequence in the a vertical direction. The absorbent accommodated in the hopper moves downward under its own weight in sequence from the adsorption tower, the recovery tower, the dryer tower, and the cooling tower, and is loaded into the hopper by the conveyer. Such circulation of the absorbent forms a movement layer formed by the absorbent in each of the towers.

In the adsorption tower of the carbon dioxide separation and recovery system of Patent Literature 1, gas to be processed and the absorbent come into contact with each other and the absorbent absorbs carbon dioxide contained in the gas to be processed. In the recovery tower, supplied water vapor comes into contact with the absorbent and thus is concentrated onto a surface of the absorbent after adsorption of the carbon dioxide. Consequently, the carbon dioxide leaves the absorbent. Carbon dioxide desorbed from the absorbent is forced to be exhausted by a pump and is stored in a carbon dioxide holder. The absorbent with attached condensed water is dried in the dryer tower, cooled in the cooling tower, returned to the hopper, and then used for absorption of carbon dioxide again.

### CITATION LIST

### Patent Literature

PTL 1: JP 2013-121562 A

### SUMMARY OF INVENTION

### Technical Problem

PTL 1 discloses the provision of air current leakage prevention means such as a lock hopper at a portion between the adsorption tower and the recovery tower to prevent a concentration reduction of carbon dioxide to be recovered due to entry of outside air into the recovery tower when a pressure in the recovery tower is lower than outside atmospheric pressure.

FIG. 8 illustrates part of a carbon dioxide separation and recovery system 100 of the related art provided with a lock hopper, including an absorption vessel 11, a desorption vessel 12, and a configuration for recovering carbon dioxide from the desorption vessel 12. In the carbon dioxide separation and recovery system 100 of the related art in FIG. 8, the desorption vessel 12 is disposed downwardly of the absorption vessel 11, and the desorption vessel 12 and a carbon dioxide holder 17 are connected by a carbon dioxide recovery pipe 31. The carbon dioxide recovery pipe 31 is provided with a pump 16, and carbon dioxide desorbed from an absorbent in the desorption vessel 12 is forced to be discharged from the desorption vessel 12 and recovered in the carbon dioxide holder 17 through the carbon dioxide recovery pipe 31.

In the carbon dioxide separation and recovery system 100 of the related art, at least one hopper (lock hopper) 61 is provided in a flow channel 21 of the absorbent. The flow channel 21 connects an outlet port of the absorption vessel 11 and an inlet port of the desorption vessel 12. An inlet valve 62 is provided at an inlet port of the hopper 61, and an outlet valve 63 is provided at the outlet port of the hopper 61. The hopper 61 is configured to be sealed by closing the inlet valve 62 and the outlet valve 63. In addition, an interior of the hopper 61 is connected to an exhaust pipe 64.

The hopper 61 descried above is operated by closing the inlet valve 62 and the outlet valve 63, introducing outside air to bring an interior pressure to a normal pressure, and then opening the inlet valve 62. Accordingly, the absorbent drops from the absorption vessel 11 to the hopper 61. Subsequently, the inlet valve 62 is closed again, and the exhaust pipe 64 and the carbon dioxide recovery pipe 31 are brought into communication with each other to forcedly exhaust a gas in the interior of the hopper 61. Once the internal pressure of the hopper 61 and the internal pressure of the desorption vessel 12 are equalized, forced exhaust is stopped and the outlet valve 63 is opened. Accordingly, the absorbent drops from the hopper 61 to the desorption vessel 12.

According to the carbon dioxide separation and recovery system 100 of the related art, the outside air is introduced into the hopper 61. Therefore, a gas fed from the hopper 61 into the carbon dioxide holder 17 through the exhaust pipe 64 and the carbon dioxide recovery pipe 31 contains the outside air. In this manner, the concentration of carbon dioxide in the carbon dioxide holder 17 may be lowered due to the outside air introduced into the carbon dioxide holder 17.

In view of such circumstances, it is an object of the present invention to provide a carbon dioxide recovery system improved to suppress lowering of concentration of carbon dioxide to be recovered in a carbon dioxide holder, and a carbon dioxide separation and recovery system including the same.

### Solution to Problem

A carbon dioxide recovery system according to an aspect of the present invention includes: an desorption vessel configured to accommodate an absorbent that has absorbed carbon dioxide and cause the carbon dioxide to be desorbed from the absorbent, the absorbent being in a solid state; a carbon dioxide holder connected to the desorption vessel via a carbon dioxide recovery pipe; a pump provided in the carbon dioxide recovery pipe and configured to feed a gas in the desorption vessel to the carbon dioxide holder via the carbon dioxide recovery pipe; and at least one pressure switching device including at least one stage of hopper, an inlet valve configured to open and close an inlet port of the hopper, an outlet valve configured to open and close an outlet port of the hopper, an exhaust pipe connected to the hopper and configured to exhaust the hopper, an exhaust valve configured to open and close the exhaust pipe, an air supply pipe connected to the hopper and configured to supply carbon dioxide to the hopper, and an air supply valve configured to open and close the air supply pipe, in which one of the at least one pressure switching device is provided on the desorption vessel at a portion upward of an inlet port of the absorbent, and the outlet port of the hopper is in communication with the desorption vessel.

A carbon dioxide separation and recovery system according to another aspect of the present invention includes: an absorption vessel configured to cause an absorbent to absorb carbon dioxide contained in a gas to be processed to an absorbent; and the carbon dioxide recovery system disposed downward of the absorption vessel.

In the carbon dioxide recovery system and the carbon dioxide separation and recovery system, for pressurizing the hopper of the pressure switching device, carbon dioxide flows from an air supply pipe into the hopper. For depressurizing the hopper, the hopper is exhausted through the exhaust pipe. Through exhaust of the hopper and supply of carbon dioxide to the hopper, the interior of the hopper accommodating the absorbent is filled with a gas having a higher concentration of carbon dioxide than outside air. Accordingly, the concentration of carbon dioxide in the gas flowing into the desorption vessel together with the absorbent when the absorbent is loaded from the hopper to the desorption vessel is higher than the concentration of outside air. Consequently, lowering of the concentration of the carbon dioxide to be recovered to the carbon dioxide holder can be suppressed.

In the carbon dioxide recovery system and the carbon dioxide separation and recovery system, the air supply pipe may be connected to at least one of the carbon dioxide recovery pipe at a portion downstream of the pump and the carbon dioxide holder.

Accordingly, carbon dioxide in the carbon dioxide holder and/or the carbon dioxide recovery pipe is introduced into the hopper, and thus the introduced carbon dioxide can cover carbon dioxide to be supplied to the hopper in the system.

In the carbon dioxide recovery system, a buffer tank is provided on the carbon dioxide recovery pipe at a portion upstream of the pump, and the air supply pipe is connected to the buffer tank.

Accordingly, the carbon dioxide accommodated in the buffer tank is fed to the hopper of the pressure switching device, and thus a stable operation of the pump is achieved by reducing a pressure variation in the carbon dioxide recovery pipe.

In the carbon dioxide recovery system, the exhaust pipe may be connected to the carbon dioxide recovery pipe at a portion upstream of the pump.

Accordingly, an exhaust machine for exhausting the gas from the interior of the hopper can be used simultaneously with the pump provided in the carbon dioxide recovery pipe. A gas forcedly discharged from the hopper is mainly carbon dioxide to reduce lowering of the concentration of carbon dioxide to be recovered in the carbon dioxide holder due to exhaust from the hopper.

The carbon dioxide recovery system may be provided with a plurality of the pressure switching devices. One of the plurality of pressure switching devices may be provided on the desorption vessel at a portion downward of an outlet port of the absorbent, and the inlet port of the hopper may be in communication with the desorption vessel.

Accordingly, an inflow of the outside air into the desorption vessel when the absorbent is discharged from the desorption vessel can be reduced and, consequently, lowering of the concentration of the carbon dioxide to be recovered in the carbon dioxide holder can be suppressed.

### Advantageous Effects of Invention

The present invention provides an improved carbon dioxide recovery system in increasing concentration of carbon dioxide to be recovered in the carbon dioxide holder, and a carbon dioxide separation and recovery system including the same.

### BRIEF DESCRIPTION OF DRAWINGS

FIG. 1 is a diagram illustrating a schematic configuration of a carbon dioxide separation and recovery system according to an embodiment of the present invention.

FIG. 2 is a block diagram illustrating a schematic configuration of a control system of a pressure switching device.

FIG. 3 illustrates Modification 1 of the carbon dioxide separation and recovery system in FIG. 1 in which an air supply pipe is connected to a carbon dioxide source.

FIG. 4 illustrates Modification 2 of the carbon dioxide separation and recovery system in FIG. 1 in which a buffer tank is provided in a carbon dioxide recovery pipe.

FIG. 5 illustrates Modification 3 of the carbon dioxide separation and recovery system in FIG. 1 in which an exhaust pipe is connected to an exhaust machine.

FIG. 6 illustrates Modification 4 of the carbon dioxide separation and recovery system in FIG. 1 in which a pressure switching device is provided in a flow channel extending from a desorption vessel to a dryer vessel.

FIG. 7 illustrates Modification 5 of the carbon dioxide separation and recovery system in FIG. 1 in which a pressure switching device is provided in a flow channel extending from a desorption vessel to a dryer vessel.

FIG. 8 is a diagram illustrating an absorption vessel, a desorption vessel, and a configuration for recovering carbon dioxide from the desorption vessel in a carbon dioxide separation and recovery system of the related art.

### DESCRIPTION OF EMBODIMENT

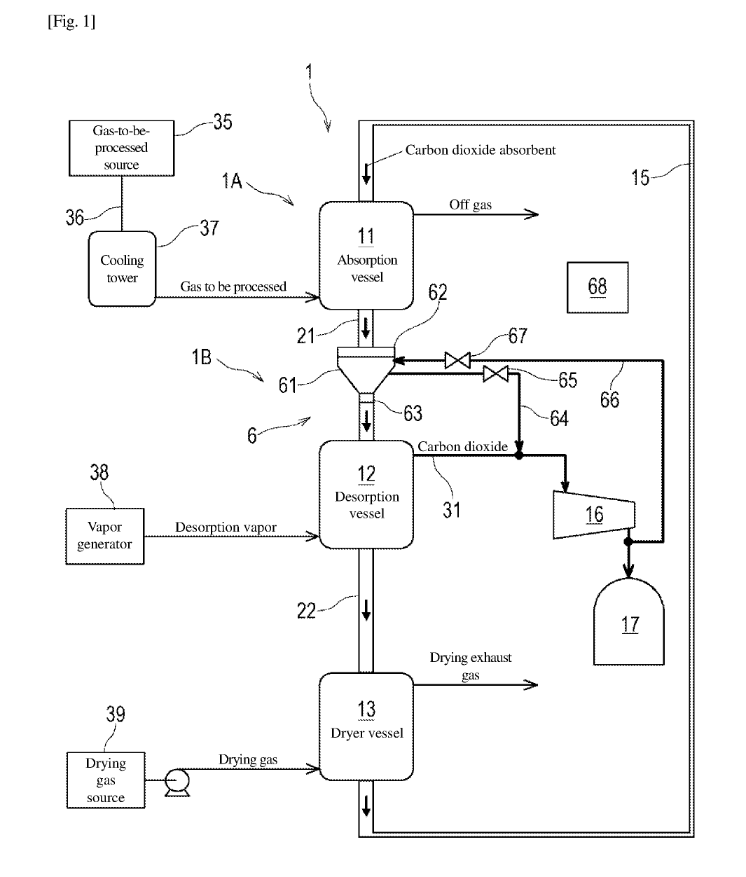

A carbon dioxide recovery system according to an embodiment of the present invention will be described. FIG. 1 is a diagram illustrating a schematic configuration of a carbon dioxide separation and recovery system 1 according to an embodiment of the present invention. The carbon dioxide separation and recovery system 1 illustrated in FIG. 1 includes a carbon dioxide separation portion 1A configured to selectively separate carbon dioxide contained in a gas to be processed by using a solid-state carbon dioxide absorbent (which may be referred to simply as “absorbent”), and a carbon dioxide recovery portion 1B (carbon dioxide recovery system) configured to desorb (separate) carbon dioxide from the absorbent.

The carbon dioxide separation and recovery system 1 according to the embodiment circulates the absorbent between the carbon dioxide separation portion 1A and the carbon dioxide recovery portion 1B for continuous processing. The absorbent is, for example, a porous substance carrying an amine compound. Examples of applicable porous substance include silica gel, an active carbon, an active alumina, and a metallic oxide.

FIG. 1 is a diagram illustrating a schematic configuration of a carbon dioxide separation and recovery system 1 according to an embodiment of the present invention. The carbon dioxide separation and recovery system 1 illustrated in FIG. 1 includes an absorption vessel 11, a desorption vessel 12, a dryer vessel 13, and a conveyer 15 configured to carry an absorbent from an outlet port of the dryer vessel 13 to an inlet port of the absorption vessel 11. For allowing the absorbent to move from the absorption vessel 11 to the dryer vessel 13 by a gravitational force, the absorption vessel 11, the desorption vessel 12, and the dryer vessel 13 are arranged in this order from the top in the vertical direction.

The absorption vessel 11 receives a supply of the absorbent conveyed by the conveyer 15 from an inlet port provided on an upper portion at a predetermined supply rate. A hopper (not illustrated) configured to temporarily accommodate the absorbent may be provided above the absorption vessel 11 to supply the absorbent from the hopper to the absorption vessel 11 at a predetermined rate. In the absorption vessel 11, the absorbent moves from the top toward the bottom at a predetermined rate by being supplied from an inlet port located at an upper portion of the vessel and being discharged from an outlet port at a bottom portion of the vessel.

A gas to be processed generated at a gas-to-be-processed source 35 is introduced into a lower portion of the absorption vessel 11 through a gas-to-be-processed supply pipe 36. The gas to be processed is gas containing 10 to 30% of carbon dioxide such as a combustion exhaust gas at a pressure in the vicinity of an ordinary pressure. The gas-to-be-processed supply pipe 36 is provided with a cooling tower 37, and the gas to be processed is cooled to a temperature adequate to absorption reaction of carbon dioxide in the cooling tower 37. The gas to be processed may be introduced into the absorption vessel 11 after preprocessing such as desulfurization, dedusting, temperature decrease, and dehumidification in addition to cooling.

In the absorption vessel 11, a countercurrent moving bed is formed, in which the gas to be processed flowing upward and the absorbent flowing downward are constantly in contact with each other. When the gas to be processed comes into contact with the absorbent, the absorbent selectively absorbs carbon dioxide. The temperature of the absorbent at that time is, for example, 40° C. The supply rate of the gas to be processed and movement rate of the absorbent are determined to complete absorption of the carbon dioxide within a detention period in the absorption vessel 11 of the absorbent or to complete desorption of carbon dioxide from the absorbent in the desorption vessel 12.

The gas to be processed after the separation of carbon dioxide (off gas) is discharged from the upper portion of the absorption vessel 11. In contrast, the absorbent that has absorbed carbon dioxide is discharged from a lower portion of the absorption vessel 11. The desorption vessel 12 is disposed at a portion downward of the absorption vessel 11, and a flow channel 21 connecting an outlet port provided at the lower portion of the absorption vessel 11 and an inlet port provided at an upper portion of the desorption vessel 12 is defined mainly by piping and a pressure switching device 6 described later. The absorbent discharged from the lower portion of the absorption vessel 11 moves under its own weight through the flow channel 21 to an inlet port of the desorption vessel 12.

In the desorption vessel 12, the absorbent that has absorbed the carbon dioxide moves in the vessel from the top toward the bottom at a predetermined rate. A lower portion of the desorption vessel 12 receives a supply of desorption vapor supplied form a vapor generator 38. However, the desorption vapor supplied to the desorption vessel 12 may be generated in the dryer vessel 13.

In the desorption vessel 12, a countercurrent moving bed is formed, in which the desorption vapor flowing upward and the absorbent flowing downward are constantly in contact with each other. When the desorption vapor comes into contact with the absorbent, the desorption vapor is condensed on a surface of the absorbent, and simultaneously emits condensation heat. In this embodiment, the condensation heat is used as energy for desorption of carbon dioxide from the absorbent. Desorption of carbon dioxide by condensation of the desorption vapor is completed in a short time after the contact between the desorption vapor and the absorbent, and the interior of the desorption vessel 12 is filled with substantially 100% carbon dioxide.

An upstream-side end of the carbon dioxide recovery pipe 31 is connected to the upper portion of the desorption vessel 12. A downstream-side end of the carbon dioxide recovery pipe 31 is connected to the carbon dioxide holder 17 for storing carbon dioxide. The carbon dioxide recovery pipe 31 is provided with a pump 16 configured to feed a gas in the desorption vessel 12 to the carbon dioxide holder 17. The pump 16 according to the embodiment is a compression pump, and the gas in the desorption vessel 12 (that is, carbon dioxide) is forcedly discharged to the carbon dioxide recovery pipe 31, is compressed by the pump 16, and is stored in the carbon dioxide holder 17.

In contrast, the absorbent containing condensed water after the desorption of carbon dioxide is discharged from the lower portion of the desorption vessel 12. The dryer vessel 13 is disposed at a portion downward of the desorption vessel 12, and a flow channel 22 connecting an outlet port provided at a lower portion of the desorption vessel 12 and an inlet port provided at an upper portion of the dryer vessel 13 is defined by piping, for example. The absorbent discharged from the lower portion of the desorption vessel 12 moves through the flow channel 22 to an inlet port of the dryer vessel 13.

In the dryer vessel 13, absorption containing condensed water moves in the vessel from the top toward the bottom at a predetermined rate, and is dried during the movement in the dryer vessel 13. The absorbent is dried by contact between drying gas supplied from the drying gas source 39 to a lower portion of the dryer vessel 13 and flowing upward in the vessel and an absorbent moving downward in the vessel. The drying gas in contact with the absorbent gets rid of water from the absorbent. The drying gas (drying exhaust gas) used for drying the absorbent is discharged from the upper portion of the dryer vessel 13

Note that drying of the absorbent in the dryer vessel 13 may be achieved by indirectly heating the absorbent using a heat medium such as water vapor and heated water. Such indirect heating of the absorbent converts the condensed water contained in the absorbent into water vapor again. The water vapor may be supplied to the desorption vessel 12 and used as desorption vapor.

The absorbent after dried is discharged from the lower portion of the dryer vessel 13. The absorbent discharged from the dryer vessel 13 drops onto the conveyer 15, is transferred to the absorption vessel 11 by the conveyer 15, and is reused as the absorbent of carbon dioxide. During the transfer by the conveyer 15, the temperature of the absorbent is lowered by heat dissipation to approximately 40° C., which corresponds to an absorption temperature of carbon dioxide in the absorption vessel 11. However, when the temperature of the absorbent is not lowered to the absorption temperature during the transfer on the conveyer 15, a cooling vessel (not illustrated) may be provided at a midstream of the conveyer 15.

In the carbon dioxide separation and recovery system 1 having the configuration described above, the pressure in the interior of the desorption vessel 12 is depressurized to a pressure lower than an ordinary pressure by forcedly discharging a gas in the desorption vessel 12. In contrast, the interior of the absorption vessel 11 has a substantially ordinary pressure. In order to switch the pressure between the absorption vessel 11 and the desorption vessel 12, the pressure switching device 6 is provided in the flow channel 21 extending form an outlet port of the absorption vessel 11 to an inlet port of the desorption vessel 12. Part or an entire part of the flow channel 21 may be formed by the pressure switching device 6.

The pressure switching device 6 is provided with at least one stage of hopper 61. Here, the pressure switching device 6 is provided with the one stage of hopper 61 for the sake of convenience for description. However, the pressure switching device 6 may be provided with a plurality of stages of hoppers 61 having the same or similar configuration and arranged in series in the vertical direction.

An inlet valve 62 configured to open and close a flow channel from the outlet port of the absorption vessel 11 to the inlet port of the hopper 61 at an inlet port of the hopper 61 or in the vicinity of the inlet port of the hopper 61. When the inlet valve 62 is opened, the outlet port of the absorption vessel 11 communicates with the interior of the hopper 61. An outlet valve 63 configured to open and close the flow channel from the outlet port of the hopper 61 to the inlet port of the desorption vessel 12 is provided at an outlet port of the hopper 61 or in the vicinity of the outlet port of the hopper. When the outlet valve 63 is opened, the interior of the hopper 61 communicates with the inlet port of the desorption vessel 12. When the inlet valve 62 and the outlet valve 63 are closed, the interior of the hopper 61 is sealed to allow depressurization or pressurization.

An upstream-side end of the exhaust pipe 64 is connected to the hopper 61. A downstream-side end of the exhaust pipe 64 is connected to the carbon dioxide recovery pipe 31 at a portion upstream of the pump 16. The exhaust pipe 64 is provided with an exhaust valve 65 configured to open and close the in-pipe flow channel for switching the connection between the hopper 61 and the carbon dioxide recovery pipe 31 between a communicating state and a shut-off state.

In addition, a downstream-side end of the air supply pipe 66 is connected to the hopper 61. The upstream-side end of the air supply pipe 66 is connected to the carbon dioxide recovery pipe 31 at a portion downstream of the pump 16. The air supply pipe 66 is provided with an air supply valve 67 configured to open and close the in-pipe flow channel for switching the connection between the hopper 61 and the carbon dioxide recovery pipe 31 between the communicating state and the shut-off state.

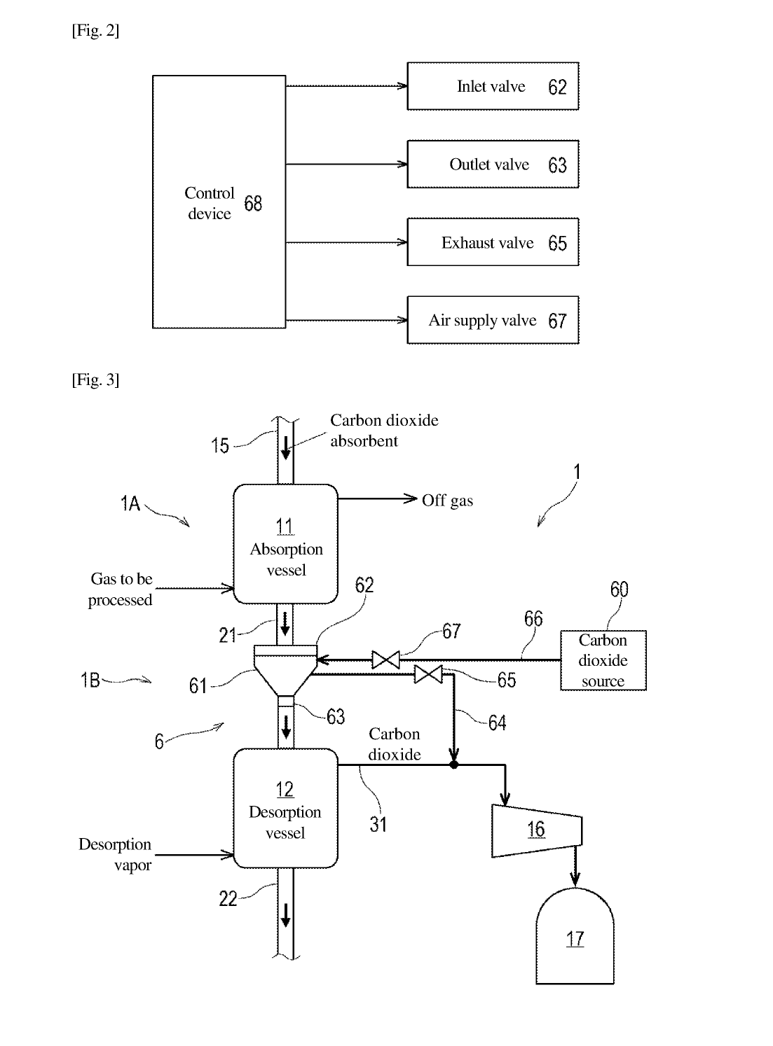

FIG. 2 is a block diagram illustrating a schematic configuration of a control system of a pressure switching device 6. As illustrated in FIG. 2, each of the inlet valve 62, the outlet valve 63, an exhaust valve 65, and the air supply valve 67 (more specifically, a drive portion of each valve) is electrically connected to a control device 68 by wire or wireless means. The control device 68 controls operations of the inlet valve 62, the outlet valve 63, the exhaust valve 65, and the air supply valve 67 based on a command input by an operator via input means, not illustrated, or based on a program stored in advance.

Subsequently, the flow of the operation of the pressure switching device 6 will be described. Although not expressed specifically in the following description, the operations of the inlet valve 62, the outlet valve 63, the exhaust valve 65, and the air supply valve 67 is controlled by the control device 68.

A state in which the interior of the hopper 61 is empty and all of the inlet valve 62, the outlet valve 63, the exhaust valve 65, and the air supply valve 67 are closed is defined as an initial state. The interior of the hopper 61 in the initial state is filled with carbon dioxide supplied from the carbon dioxide recovery pipe 31 through the air supply pipe 66 and thus has a substantially ordinary pressure.

First of all, the inlet valve 62 is opened from the above-described initial state. The absorbent then drops from the absorption vessel 11 into the hopper 61. In this state, the interior of the hopper 61 is in communication with the absorption vessel 11 at an air atmosphere. However, carbon dioxide is heavier than air and, in addition, the carbon dioxide in the hopper 61 is pushed out into the absorption vessel 11 by the absorbent flowing inward. Therefore, air in the absorption vessel 11 is prevented from flowing easily into the hopper 61. When a predetermined amount of absorbent is accommodated in the hopper 61, or when a predetermined period has elapsed since the inlet valve 62 is opened, the inlet valve 62 is closed.

Subsequently, the exhaust valve 65 is opened. Consequently, the hopper 61 and the carbon dioxide recovery pipe 31 are brought into communication with each other via the exhaust pipe 64, and a gas in the hopper 61 is forcedly discharged by a suction force of the pump 16. The air discharged from the hopper 61 is accommodated in the carbon dioxide holder 17 via the exhaust pipe 64 and the carbon dioxide recovery pipe 31. Since the most part of the exhaust from the hopper 61 is carbon dioxide, the concentration of the carbon dioxide in the carbon dioxide holder 17 is little affected by the exhaust from the hopper 61 accommodated in the carbon dioxide holder 17.

When the pressure in the hopper 61 and the pressure in the desorption vessel 12 are almost equalized by the forced exhaust from the above-described hopper 61, the exhaust valve 65 is closed and the outlet valve 63 is opened. Accordingly, the absorbent accommodated temporarily in the hopper 61 drops into the desorption vessel 12. When the entire absorbent accommodated temporarily in the hopper 61 is discharged, or when a predetermined time has elapsed since the outlet valve 63 is opened, the outlet valve 63 is closed.

Finally, the air supply valve 67 is opened and the carbon dioxide recovery pipe 31 (the carbon dioxide holder 17) is introduced from the carbon dioxide recovery pipe 31 (the carbon dioxide holder 17) into the hopper 61 through the air supply pipe 66. When the pressure in the hopper 61 and the pressure in the absorption vessel 11 are almost equalized, that is, when the pressure in the hopper 61 is brought into an ordinary pressure, the air supply valve 67 is closed. Accordingly, the pressure switching device 6 (the hopper 61) is restored to the initial state.

As described above, the carbon dioxide separation and recovery system 1 of the embodiment includes the carbon dioxide separation portion 1A including the absorption vessel 11 configured to perform processing for causing the absorbent to absorb carbon dioxide contained in the gas to be processed and the carbon dioxide recovery portion 1B (carbon dioxide recovery system) described above. The carbon dioxide recovery portion 1B includes the desorption vessel 12 configured to accommodate the solid-state absorbent that has absorbed the carbon dioxide and desorb the carbon dioxide from the absorbent, the carbon dioxide holder 17 connected to the desorption vessel 12 via the carbon dioxide recovery pipe 31, the pump 16 provided in the carbon dioxide recovery pipe 31 and configured to feed a gas in the desorption vessel 12 to the carbon dioxide holder 17 through the carbon dioxide recovery pipe 31, and at least one pressure switching device 6. The pressure switching device 6 includes at least one stage of hopper 61, the inlet valve 62 configured to open and close the inlet port of the hopper 61, the outlet valve 63 configured to open and close the outlet port of the hopper 61, the exhaust pipe 64 connected to the hopper 61 and configured to exhaust the hopper 61, the exhaust valve 65 configured to open and close the exhaust pipe 64, the air supply pipe 66 connected to the hopper 61 and configured to supply carbon dioxide to the hopper 61, and the air supply valve 67 configured to open and close the air supply pipe 66. One of the at least one pressure switching device 6 is provided at a portion upward of the inlet port of the desorption vessel 12 for the absorbent, the inlet port of the hopper 61 and the outlet port of the absorption vessel 11 for the absorbent are in communication with each other, and the outlet port of the hopper 61 is in communication with the desorption vessel 12.

In the carbon dioxide separation and recovery system 1 having the configuration described above, when the hopper 61 is pressurized to the ordinary pressure (to the internal pressure of the absorption vessel 11), carbon dioxide flows into the hopper 61 through the carbon dioxide recovery pipe 31 and the air supply pipe 66. When the pressure in the hopper 61 is depressurized to the internal pressure of the desorption vessel 12 from the ordinary pressure, a gas forcedly discharged from the hopper 61 is fed to the carbon dioxide holder 17 through the exhaust pipe 64 and the carbon dioxide recovery pipe 31. Through exhaust of the hopper 61 and supply of carbon dioxide to the hopper 61, the interior of the hopper 61 accommodating the absorbent is filled with a gas having a higher carbon dioxide than outside air. Accordingly, the concentration of carbon dioxide in the gas flowing into the desorption vessel 12 together with the absorbent when the absorbent is loaded from the hopper 51 to the desorption vessel 12 is higher than the concentration of the outside air. Consequently, lowering of the concentration of the carbon dioxide to be recovered to the carbon dioxide holder 17 can be suppressed.

In the embodiment, the air supply pipe 66 is connected to the carbon dioxide recovery pipe 31 at a portion downstream of the pump 16. Accordingly, carbon dioxide in the carbon dioxide recovery pipe 31 is introduced into the hopper 61, and thus the introduced carbon dioxide covers carbon dioxide to be supplied to the hopper 61 in the system. Therefore, not only the piping is simplified, but also an operation of replenishing carbon dioxide is not necessary.

In the embodiment, the exhaust pipe 64 is connected to the carbon dioxide recovery pipe 31 at a portion upstream of the pump 16. Accordingly, an exhaust machine for exhausting the gas from the interior of the hopper 61 can be used simultaneously with the pump 16 provided in the carbon dioxide recovery pipe 31. Therefore, the number of components can be reduced, and thus an initial cost can be reduced. Here, the gas flowing into the carbon dioxide recovery pipe 31 from the hopper 61 through the exhaust pipe 64 is mainly carbon dioxide. Accordingly, since the gas is accommodated in the carbon dioxide holder 17, influence on the concentration of the carbon dioxide accommodated in the carbon dioxide holder 17 can be reduced.

In other words, according to the carbon dioxide separation and recovery system 1, lowering of the concentration of carbon dioxide to be recovered in the carbon dioxide holder 17 can be suppressed and thus recovery of carbon dioxide at a high concentration can be achieved. In general, the carbon dioxide to be stored is required to have a concentration as high as 95% or more, and carbon dioxide that is a material of dry ice is required to have a high concentration as high as 99% or more. In this manner, since carbon dioxide to be used or to be stored requires a high concentration, it is advantageous that carbon dioxide can be recovered at a higher concentration. Since carbon dioxide can be recovered at a higher concentration, energy required for compression processing for compressing carbon dioxide in a concentration vessel, which may be performed as preprocessing before usage or storage, may be saved.

The configuration of the carbon dioxide separation and recovery system 1 described above can be modified, for example, as described below. A plurality of modifications described below may be used by combining modified parts.

In the carbon dioxide separation and recovery system 1 according to the embodiment, the air supply pipe 66 is connected to the carbon dioxide recovery pipe 31 at a portion downstream of the pump 16, and carbon dioxide in the carbon dioxide recovery pipe 31 is supplied to the hopper 61. However, in addition to or instead of the configuration described above, other carbon dioxide source may be connected to the hopper 61. For example, in a modification illustrated in FIG. 3, an upstream end of the air supply pipe is connected to a carbon dioxide source 60. The carbon dioxide source 60 may be a portion of the carbon dioxide recovery pipe 31 downward of the pump 16 as in the embodiment described above or may be the carbon dioxide holder 17. Alternatively, the carbon dioxide source 60 may be at least one of a carbon dioxide tank provided separately from the carbon dioxide holder 17, a boiler configured to discharge combustion exhaust gas including carbon dioxide at a high concentration, and a system configured to discharge exhaust gas containing carbon dioxide at a high concentration.

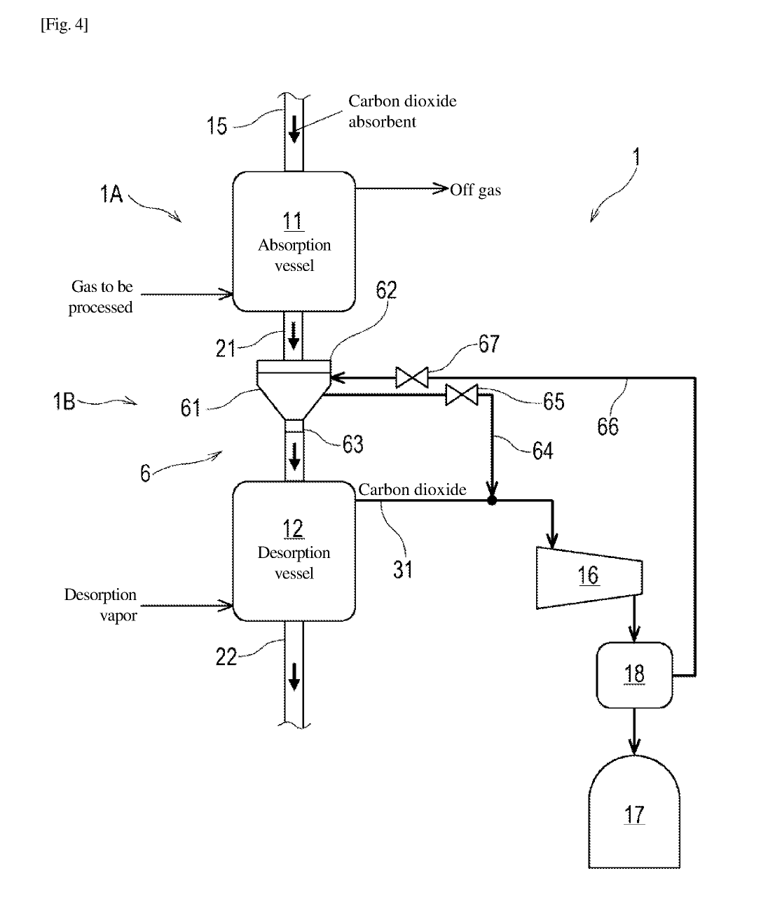

In the carbon dioxide separation and recovery system 1 according to the embodiment described above, the air supply pipe 66 is connected to the carbon dioxide recovery pipe 31 at a portion downstream of the pump 16. However, as illustrated in a modification in FIG. 4, a buffer tank 18 may be provided on the carbon dioxide recovery pipe 31 at a portion between a portion of the carbon dioxide recovery pipe 31 downstream of the pump 16 and the carbon dioxide holder 17, and the upstream end of the air supply pipe 66 may be connected to the buffer tank 18.

In the buffer tank 18 described above, carbon dioxide flowed into the buffer tank 18 through the carbon dioxide recovery pipe 31 is uniformized in pressure. Therefore, the carbon dioxide uniformized in the buffer tank 18 is supplied to the hopper 61 via the air supply pipe 66, and thus the carbon dioxide can be stably supplied to the air supply pipe 66. In addition, with the buffer tank 18 provided in the carbon dioxide recovery pipe 31, a pressure variation that the pump 16 receives by supplying carbon dioxide to the air supply pipe 66 can be alleviated and thus the operation of the pump 16 can be stabilized.

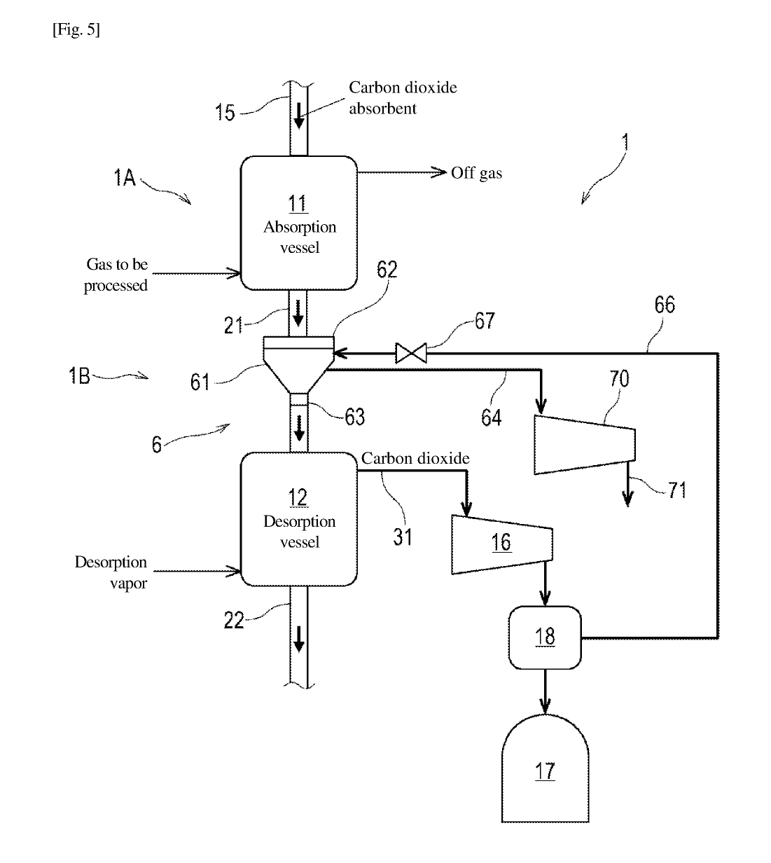

In the carbon dioxide separation and recovery system 1 according to the embodiment, the exhaust pipe 64 is connected to the carbon dioxide recovery pipe 31 at the portion upstream of the pump 16. In other words, the exhaust pipe 64 is connected to the pump 16. The pump 16 in this case functions as a discharge machine configured to discharge gas in the interior of the hopper 61. However, in addition to or instead of the configuration described above, other type of exhaust machine may be connected to the exhaust pipe 64. For example, in a modification illustrated in FIG. 5, an exhaust machine 70 is connected to the exhaust pipe 64. The exhaust machine 70 is a pump or a compression machine provided independently from the pump 16. In this case, the exhaust valve 65 provided in the exhaust pipe 64 in the embodiment described above may be omitted. In addition, an exhaust pipe 71 of the exhaust machine 70 may be connected to at least one of the buffer tank 18 and the carbon dioxide holder 17, or may be opened to the atmosphere.

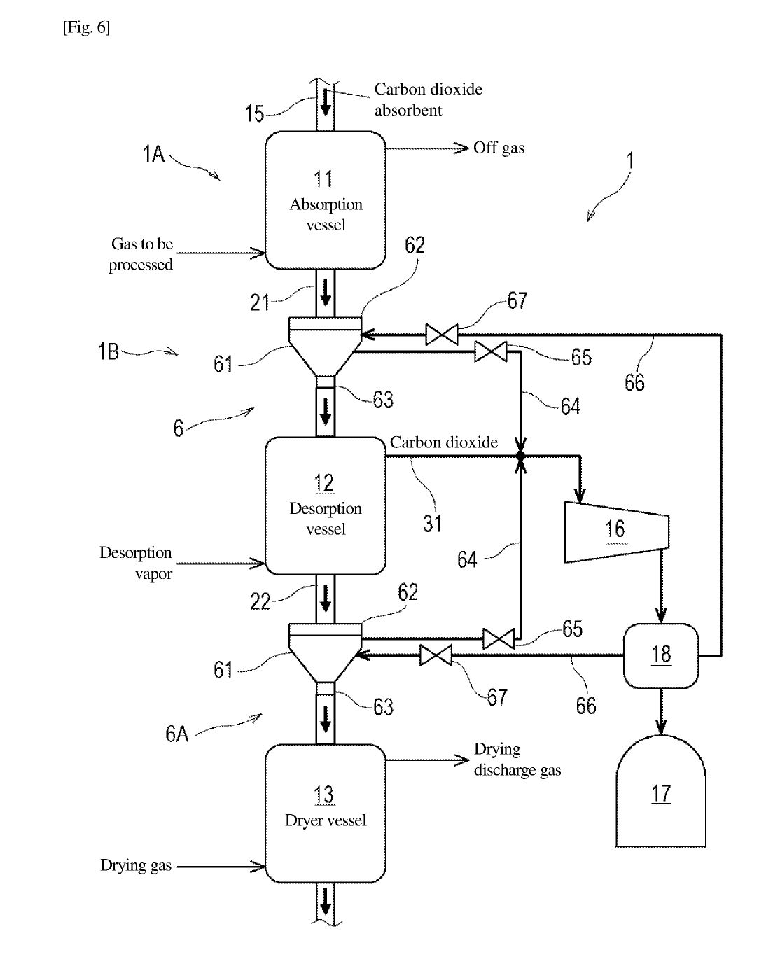

The carbon dioxide separation and recovery system 1 according to the embodiment described above, the pressure switching device 6 is provided in the flow channel 21 from the outlet port of the absorption vessel 11 to the inlet port of the desorption vessel 12. However, as illustrated in the modification of FIG. 6, a pressure switching device 6′ may be provided in the flow channel 21 from the outlet port of the desorption vessel 12 to the inlet port of the dryer vessel 13. In this case, the two pressure switching devices 6, 6′ may have substantially the same configuration. In FIG. 6, the same reference signs are allocated to corresponding components of the two pressure switching devices 6, 6′. The inlet port of the hopper 61 of the pressure switching device 6′ is in communication with the outlet port of the absorbent of the desorption vessel 12, and the outlet port of the hopper 61 is in communication with the inlet port of the dryer vessel 13 for the absorbent.

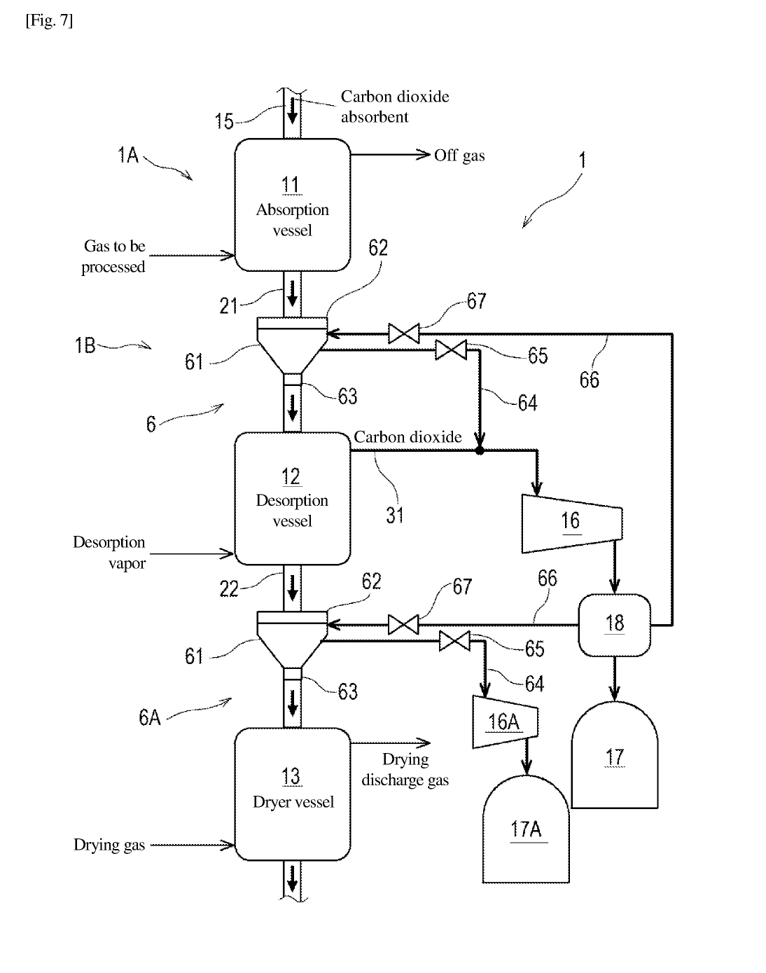

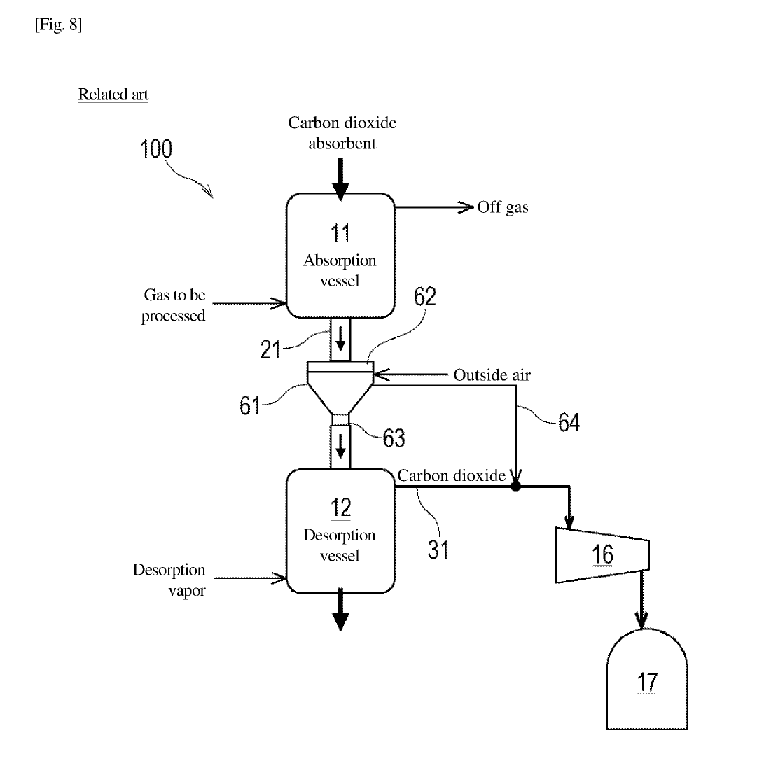

However, as illustrated in the modification of FIG. 7, a gas discharged from the hopper 61 of the pressure switching device 6′ may be recovered in a second carbon dioxide holder 17A different from the carbon dioxide holder 17. In this case, in the pressure switching device 6′ provided in the flow channel 22 for the absorbent from the desorption vessel 12 to the dryer vessel 13, the hopper 61 and the second carbon dioxide holder 17A may be connected by the exhaust pipe 64 and a pump 16A may be provided in an exhaust pipe 64. In FIGS. 6 and 7, the upstream-side end of the air supply pipe 66 is connected to the buffer tank 18. However, the upstream-side end of the air supply pipe 66 may be connected to the carbon dioxide recovery pipe 31 at a portion downstream of the pump 16 except for the buffer tank 18.

As described above, due to provision of the pressure switching device 6′ on the outlet port side at a portion downward of the outlet port of the desorption vessel 12 for the absorbent, inflow of outside air into the desorption vessel 12 can be reduced when the absorbent is discharged from the desorption vessel 12. Accordingly, lowering of the concentration of the carbon dioxide to be recovered to the carbon dioxide holder 17 can be suppressed.

The preferred embodiment of the present invention (and the modifications) has been described thus far. From the description, many improvements and other embodiments are apparent for those skilled in the art. Therefore, the description given above should be recognized as illustration only, and is provided for the purpose of teaching those skilled in the art the best mode for carrying out the present invention. Various modifications in structure and/or function in detail can be made without departing the spirit of the present invention.

### REFERENCE SIGNS LIST

1 carbon dioxide separation and recovery system
1A carbon dioxide separation portion
1B carbon dioxide recovery portion (carbon dioxide recovery system)
6, 6′ pressure switching device
11 absorption vessel
12 desorption vessel
13 dryer vessel
15 conveyer
16, 16A pump
17, 17A carbon dioxide holder
18 buffer tank
21 flow channel
22 flow channel
31 carbon dioxide recovery pipe
60 carbon dioxide source
61 hopper (lock hopper)
62 inlet valve
63 outlet valve
64 exhaust pipe
65 exhaust valve
66 air supply pipe
67 air supply valve
68 control device
70 exhaust machine

1. A carbon dioxide recovery system comprising:
an desorption vessel configured to accommodate an absorbent that has absorbed carbon dioxide and cause the carbon dioxide to be desorbed from the absorbent, the absorbent being in a solid state;
a carbon dioxide holder connected to the desorption vessel via a carbon dioxide recovery pipe;
a pump provided in the carbon dioxide recovery pipe and configured to feed a gas in the desorption vessel to the carbon dioxide holder via the carbon dioxide recovery pipe; and
at least one pressure switching device including:
at least one stage of hopper;
an inlet valve configured to open and close an inlet port of the hopper;
an outlet valve configured to open and close an outlet port of the hopper;
an exhaust pipe connected to the hopper and configured to exhaust the hopper;
an exhaust valve configured to open and close the exhaust pipe;
an air supply pipe connected to the hopper and configured to supply carbon dioxide to the hopper; and
an air supply valve configured to open and close the air supply pipe, wherein
one of the at least one pressure switching device is provided on the desorption vessel at a portion upward of an inlet port for the absorbent, and the outlet port of the hopper is in communication with the desorption vessel.

2. The carbon dioxide recovery system according to claim 1, wherein the air supply pipe is connected to at least one of the carbon dioxide recovery pipe at a portion downstream of the pump and the carbon dioxide holder.

3. The carbon dioxide recovery system according to claim 2, comprising a buffer tank on the carbon dioxide recovery pipe at a portion upstream of the pump, wherein
the air supply pipe is connected to the buffer tank.

4. The carbon dioxide recovery system according to claim 1, wherein the exhaust pipe is connected to the carbon dioxide recovery pipe at a portion upstream of the pump.

5. The carbon dioxide recovery system according to claim 1, comprising a plurality of the pressure switching devices, wherein one of the plurality of pressure switching devices is provided on the desorption vessel at a portion downward of an outlet port of the absorbent, and the inlet port of the hopper is in communication with the desorption vessel.

6. A carbon dioxide separation and recovery system comprising:
an absorption vessel configured to cause an absorbent to absorb carbon dioxide contained in a gas to be processed; and
the carbon dioxide recovery system according to claim 1, the carbon dioxide recovery system being disposed downward of the absorption vessel.
